(19) United States
(12) Patent Application Publication
(10) Pub. No.: US 2012/0068827 A1
(43) Pub. Date: Mar. 22, 2012

(54) SELF-POWERED RFID SENSING SYSTEM FOR STRUCTURAL HEALTH MONITORING

(75) Inventors: Jia Yi, Mayaguez, PR (US); Nicolas A. Gay, Dresden (DE); Qiuyun Fu, Dresden (DE); Bernd Frankenstein, Radeberg (DE); Wolf-Joachim Fischer, Dresden (DE); Norbert Meyendorf, Langebruck (DE)

(73) Assignee: FRAUNHOFER-GESELLSCHAFT ZUR FORDERUNG DER ANGEWANDTEN FORSCHUNG E.V., Munchen (DE)

(21) Appl. No.: 13/203,464

(22) PCT Filed: Feb. 25, 2009
(86) PCT No.: PCT/EP09/01345

§ 371 Date: Dec. 7, 2011

(51) Int. Cl. G06K 7/01

(52) U.S. Cl. 340/10.1

(57) ABSTRACT

An RFID-based sensing system includes a piezoelectric arrangement mountable at least partially on a structure, an RFID transponder connected to the piezoelectric arrangement, and an antenna connected to the RFID transponder and/or being integrated into the RFID transponder. The piezoelectric arrangement and/or the RFID transponder are adapted to convert kinetic energy provided by the structure into electrical energy usable for powering the RFID transponder and to generate sensing information with respect to a state of the structure. The RFID-based sensing system also includes an RFID reader.

### CROSS-REFERENCE TO RELATED APPLICATIONS

The present application is a national phase application of PCT/EP2009/001345, filed pursuant to 35 U.S.C. §371, which application is incorporated by reference herein in its entirety.

### TECHNICAL FIELD

The present invention relates to an RFID-based sensing system, an RFID-based sensing and reading system including a sensing system and a corresponding RFID-based reader and a corresponding RFID-based transmitting and receiving method that can be used for monitoring the structural health of structures (e.g. bridges, buildings, dams, pipelines or any other physical objects that are subjected to mechanical vibrations and/or to mechanical stress).

### BACKGROUND

As an abbreviation, in the following description the RFID-based sensing system is also referenced as an “RFID-based transmitter” or simply as “transmitter”. This means that in the present application the wording “transmitter” is understood in the sense of a wireless sensing system including one or more single devices providing a transmitting (and possibly also a receiving) capacity and not only in the sense of a necessarily single device transmitting means.

Structures as for example buildings, bridges, dams, pipelines, windmills, aircrafts, and/or ships are complex engineered systems that ensure society's economic and industrial prosperity. Condition monitoring of such critical structures is vital for not only assuring its safety and security during naturally occurring and malicious events, but also for determining the fatigue rate under normal aging conditions and thus allowing for efficient upgrades of the structures. The fundamental building blocks of a distributed structural health monitoring system are normally a low-cost passive sensor and sensor network technologies.

The conventional power supply for such sensor nodes, especially for wireless sensor nodes, is generally some form of a battery. As the number of sensor nodes embedded in a structure (and used to monitor a state and/or states of this structure) increases and sensor networks become more wide-spread, the conventional approach that often also relies on running wires between the local sensors and a data acquisition system and battery power supply quickly becomes unsuitable for both operational and maintenance standpoints.

In addition, implementation costs of current systems, especially of current wireless sensor systems are usually very high. Significant challenges associated with current wireless sensor technologies for structural health monitoring are finite life expectancy of portable power sources, passive wireless communication, and lowering system implementation costs.

On the other hand, it is also known from the prior art to employ radio frequency identification (RFID) wireless technologies for both the delivery of power to the sensors as well as for data communication. In this prior art a passive RFID tag (or a passive RFID transponder, the expressions of tag and of transponder are subsequently used as synonyms) utilizes the electromagnetic power received from the querying device (i.e. from the corresponding RFID reader) to power the circuit of the RFID tag/RFID transponder and thus to enable it to transmit the RF signal back to the RFID reader. The advantage of this battery-free wireless sensors is that they can operate indefinitely in the field.

However, in this technology only a short communication distance between reader and sensor node can be offered. Furthermore, this distance drastically reduces when the sensor is embedded in structural materials.

### SUMMARY

In some embodiments, the present invention provides an RFID-based sensing system or an RFID-based transmitter, respectively (and a corresponding RFID-based sensing and reading system including such a sensing system or transmitter, respectively, as well as a corresponding RFID-based transmitting and receiving method) that is able to reliably sense a state of a structure over a long time, able to be reliable and over said long time provided with sufficient power in order to transmit an information about the state of the structure over a sufficiently large distance and able to sense the state of the structure at a plurality of locations on/at the structure in a reliable way.

The present invention will be described first in a general way and then afterwards in specific advantageous embodiments.

The combination of elements that are shown in the subsequently described specific embodiments does not have to be realized in exactly the shown configuration of these specific embodiments, but can also (based on the common knowledge of the one skilled in the present technical field) be realized in other configurations within the scope of the attended claims. Especially single elements shown can be realized independent of other single elements shown.

In some embodiments, a basic idea of the present invention is to provide an RFID-based sensing system/transmitter with a piezoelectric arrangement that is adapted to be mounted and/or being mounted on a structure to be monitored, with an RFID transponder (RFID tag) adapted to be connected and/or being connected to the piezoelectric arrangement and with an antenna adapted to be connected and/or being connected to the RFID transponder and/or being integrated into the RFID transponder. Therein, then the piezoelectric arrangement and/or the RFID transponder is/are adapted to convert kinetic energy provided for example by stresses or vibrations in/of the structure into electrical energy (which is then used in order to power the RFID transponder and/or the antenna) and beyond this, to also generate sensing information with respect to a state of the structure. The antenna then transmits the sensing information (or information derived therefrom) to a corresponding RFID reader.

Piezoelectric arrangement is used for harvesting mechanical energy and/or for sensing. The output of the piezoelectric arrangement is normally electrical potential (voltage). For powering, this electrical potential can be stored as electrical energy to energize the RFID transponder, and for sensing, the same electrical potential reflects the level of stimulating physical parameter such as strain, stress or impedance of the structure. The same signal from the piezoelectric arrangement can be used for two proposes simultaneously or separately.

The piezoelectric arrangement that is used for both purposes of converting kinetic energy provided by the structure into electrical energy and of generating the sensing information includes at least one piezoelectric element that is mounted on the structure in order to monitor the state thereof. In some embodiments, the piezoelectric arrangement includes a multitude of piezoelectric elements that are mounted on the structure in order to monitor the state thereof.

Among the piezoelectric elements, piezoelectric converting and sensing elements can be used, i.e. elements that are adapted (in conjunction with the RFID transponder) to convert the kinetic energy as well as to generate sensing information with respect to the state of the structure.

It is, however, also possible to divide these two tasks and to use piezoelectric converting elements that are adapted to convert the kinetic energy on the one hand and piezoelectric sensing elements which are adapted to generate the sensing information on the other hand (i.e. the piezoelectric converting elements are in this case not used to generate sensing information and the piezoelectric sensing elements are not used to convert the kinetic energy provided by the structure, but only to generate the sensing information).

In some embodiments, especially when piezoelectric converting and sensing elements are used, it is advantageous to realize the RFID transponder and/or the piezoelectric arrangement in such a way that it is/they are adapted to alternately and in some cases periodically switch between a first state of the RFID-based transmitter in which kinetic energy provided by the structure is converted into electrical energy (and stored in an appropriate storage means) and in which no sensing information is generated and a second state in which no energy is stored, but only sensing information with respect to a state of the structure is generated.

As is further described in detail below, the RFID transponder and/or the piezoelectric arrangement, in some embodiments solely the RFID transponder, can include different subunits, as for example a sensor interface, a voltage limiter, or a voltage regulator, which are, in some embodiments, realized in the form of one integrated RFID chip.

The RFID transponder of the present invention can be an active RFID transponder, a semi-passive RFID transponder or a passive RFID transponder. In the case of using an active RFID transponder, part of the energy consumed by this transponder can be provided by the piezoelectric arrangement of the invention and part of the consumed energy can be provided by the internal power source of the active RFID transponder.

The present invention therefore relates to a preferably passive wireless sensing system for monitoring the structural health of structures like buildings and bridges . In some embodiments, the present invention is directed to the incorporation of a piezoelectric arrangement (including piezoelectric elements) that is capable of sensing critical parameters of a structure and harvesting mechanical energy, along with a passive (or also an active) RFID system for wirelessly transmitting sensor identification information and/or an indication on a condition of the structure.

In some embodiments, the therefore at least partially self-powered wireless sensing system of the present invention can include at least one piezoelectric element, an energy storage bank, an RFID chip with an antenna and an RFID reader. The piezoelectric element(s) can be mounted on a structure and be capable of sensing critical parameters of the structure as well as harvesting mechanical stresses or vibration energy of the structure in order to energize the circuitry within the RFID chip. The energy storage bank accumulates electrical charge generated by the piezoelectric element(s) in order to deliver power to the sensing system.

Power management, sensor interface, signal conditioning, non-volatile memory, a back scatter modulator/demodulator, a computing and control logic can be fully integrated into a single RFID chip with an external antenna.

The RFID reader can actuate the RFID chip of the transmitter and then receive a back scatter signal of the RFID chip which contains information about the state of the structure being monitored and preferably also sensor identification data.

The system according to the present invention (as well as the transmitter in this system) allows single or networked piezoelectric elements to simultaneously convert ambient source energy provided by the structure into electrical energy and sense the state of the structure and to wirelessly transmit an indication on the condition of the structure to an end user by means of the reader for structural health monitoring. One or more of such self-powered RFID sensing systems working as sensor nodes can be incorporated into the structure and the sensor nodes can be sequentially read by a single reader.

Advantageously, a very large scale integration RFID technology can be combined in the present invention with the piezoelectric material technology. This RFID technology may integrate a sensor interface, computing capabilities and the wireless data communication into a single chip with extreme low power consumption while the piezoelectric material can have (in the form of piezoelectric converting and sensing elements) power harvesting and sensing functionalities combined in a single element, or (in the form of separated piezoelectric converting elements and piezoelectric sensing elements) the power harvesting and sensing functionalities split up in two different parts of the piezoelectric arrangement. The low power requirements of the RFID technology coupled with an energy scavenging power source and the corresponding sensing abilities will offer a new generation of passive wireless sensing solutions and large readout distances for low duty cycle structural monitoring systems.

One type of a piezoelectric element that can be used in the present invention is a macro fiber composite (MFC) piezoelectric element of the prior art. This composite element has the advantage of providing a high strain energy density and durability and is also a soft, thin, light, and shock-resistance structure that can be used for sensing and power generation. The MFCs are especially useful in damage location with respect to structures. As sensing elements, the MFCs can serve as strain, vibration or impedance sensors, as power harvesting elements, the MFCs can convert mechanical energy into electrical energy. Therein, the MFC electrodes can be protected by KAPTON and are then robust in corrosive environments. Such MFCs can have a reliability of over 10⁹ cycles operating at maximum strain.

A piezoelectric power harvesting element (piezoelectric converting element or piezoelectric converting and sensing element according to the invention) differs from a typical electrical power source in that its internal impedance is capacitive rather than inductive in nature and also that it is driven by time-varying strains or mechanical vibrations of varying amplitude and frequency of the structure. The advantage of an RFID transmitter/RFID sensing system also relies in the fact that the power requirement of the RFID system is much smaller than in any other wireless sensor modules of the prior art. The average power requirement of an RFID transponder chip according to the invention is typically 50 μW compared to 50 mW average power consumption during operation of a regular wireless sensor node according to the prior art. Although a piezoelectric element such as an MFC element generates a limited amount of power from a vibrating host structure, it is possible to provide enough power for the RFID transmitter/RFID sensing system to wirelessly transmit sensor data at large readout distances.

The RFID sensing system/RFID transmitter according to the present invention uses a single or multiple (networked) piezoelectric element(s) that simultaneously convey(s) ambient source energy provided by stresses or vibrations of the structure and that sense(s) the state of the structure, and wirelessly transmits sensor measurements and derives information through a passive and/or active RFID link to an end user for structural health monitoring.

The present invention therefore provides an RFID-based sensing system with an RFID-based transmitter wherein the latter includes at least one piezoelectric element, an RFID transponder/RFID chip and an antenna and in some embodiments also an energy storage bank. This system allows single or network piezoelectric elements to simultaneously convert ambient source energy provided by stress or vibration of the host structure into electrical energy, to sense the state of the structure and to wirelessly transmit information on the condition of the structure to an end user by means of a reader of the RFID sensing system. Piezoelectric elements can be used solely to harvest mechanical energy; piezoelectric elements can be used to solely generate sensing information with respect to a state of the structure. However, it is also possible to utilize those piezoelectric elements which are adapted to harvest the mechanical energy also to sense the state of the structure as well (piezoelectric converting and sensing elements).

The rectified energy harvested by the piezoelectric elements can then be stored in the energy storage bank. The state of the structure is indicated by stress, varying amplitude and spectral content and impedance of the (sensing) piezoelectric elements. When single piezoelectric elements are employed for both sensing and power harvesting, the RFID transponder can periodically alternate between these two functionalities. Further, in some embodiments, it is advantageous if the system is adapted to operate with a low-duty cycle in order to minimize average power consumption. During the recovery phase (so-called power-down mode in order to minimize the power consumption) the system can still be able to achieve restricted functionalities, among them for example basic communication functionalities and/or high-priority event handling.

The RFID-based sensing system may include a multitude of networked piezoelectric elements that are mounted on the structure. In this way, more power can be extracted from stresses and/or vibrations of the structure. If the piezoelectric elements serve as powerharvesting elements and as sensing elements as well, the rectified output energy of these elements can be stored in the energy storage bank and used in order to power the RFID-based sensing system. In some embodiments, these piezoelectric elements are, as described in detail later, alternately directed to store the energy in the energy storage bank over a predefined time interval and afterwards redirected and connected to an input of a sensor interface in order to generate and provide the corresponding sensing information of the structure. The RFID transponder therefore receives sensing information from the piezoelectric elements and transmits this information to the RFID reader. The RFID-based transmitter is powered by the energy storage bank which can be externally connected to an on-chip RFID transponder.

### BRIEF DESCRIPTION OF THE FIGURES

The present invention is now described with respect to specific embodiments. Therein, the appended Figures show the following:

FIG. 1 depicts a systematic block diagram of an RFID-based sensing and reading system according to the present invention.

FIG. 2 shows a systematic diagram of a piezoelectric element with a voltage-limiting capacitor in parallel which can be used in present invention.

FIG. 3 shows a schematic diagram of networked piezoelectric elements according to the invention, wherein the elements are piezoelectric converting and sensing elements.

FIG. 4 shows a schematic diagram of networked piezoelectric elements according to the present invention, in which one piezoelectric element is a piezoelectric sensing element and in which the other piezoelectric elements are piezoelectric converting elements.

FIG. 5 shows a possible configuration of an RFID chip according to the present invention with a single sensing and power harvesting input terminal.

FIG. 6 shows a time diagram of the RFID chip control logic relevant for the single sensing/power harvesting input shown in the embodiment of FIG. 5.

FIG. 7 shows a schematic diagram of another RFID chip according to the invention with separate sensing and power harvesting inputs.

FIG. 8 shows a schematic diagram of a sensor interface in an amplitude measurement configuration which can be used in the present invention.

FIG. 9 shows a schematic diagram of a sensor interface in an impedance measurement configuration which can be used in the present invention.

FIG. 10 shows an RFID-based sensing and reading system (or a sensor network, respectively) according to the invention which includes multiple RFID-based sensing systems according to the present invention and one single RFID-based reader.

FIGS. 11a and 11b show a macro fiber composite actuator (MFC) of the prior art which can be used as a piezoelectric element in the present invention.

### DETAILED DESCRIPTION

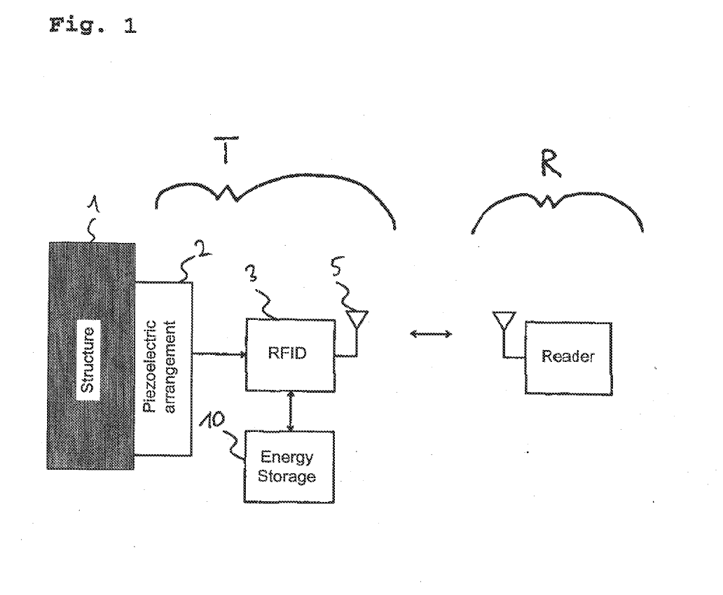

In the following FIGS. 1 to 11, the individual components of several RFID-based sensing systems or transmitters, respectively, according to the present invention and their connections are shown. The connections are shown as drawn through lines connecting the individual components that are normally drawn as rectangular boxes. The connections can be used (depending upon the individual components connected by them) either as signal transmission lines or in order to accumulate the corresponding energy or also for both purposes (which purpose applies is clear for the one skilled based on the entirety of the correspondingly shown diagram). Arrows indicate the direction of the flow of the energy and/or the corresponding information (sensing information with respect to a state of the structure and/or also for example identification information). Which individual component is connected to which other individual component can therefore be clearly seen from the diagrams in the Figures so that not each individual connection is described in full detail in the following sections.

FIG. 1 discloses a general structure of an RFID-based sensing system according to the invention. On a structure 1, which can for example be an airplane, a dam, a building or the like, a piezoelectric arrangement 2 is arranged. As is seen in the other Figures, this piezoelectric arrangement 2 includes multiple piezoelectric elements that are arranged respectively in contact with either the surface of or the interior of the structure.

The piezoelectric arrangement, i.e. all piezoelectric elements of it, are then electrically connected to an RFID transponder 3 which is, together with the piezoelectric arrangement 2, adapted to convert kinetic energy provided by the structure into electrical energy and to generate sensing information with respect to a state of the structure 1. To store this energy, the RFID transponder 3 is connected to an external energy storage 10 in the form of a rechargeable battery.

Finally, the RFID transponder 3 is electrically connected to an antenna 5 that is adapted to transmit the sensing information to the RFID-based reader R of the shown RFID-based sensing system. In order to be able to receive the information and in order to provide the transmitter T of the sensing system (which includes the elements 2, 3, 5, and 10) with a wake-up signal, the reader R also includes a suitable antenna.

The piezoelectric arrangement 2 mounted on the structure 1 is therefore capable of sensing critical parameters of the structure and of harvesting mechanical stresses or vibrations energy in order to energize the circuitry of the RFID transponder 3. The energy storage bank 10 accumulates electrical charge generated by the piezoelectric elements of the piezoelectric arrangement 2 to deliver continuous or low-duty cycle power to the system. As will be seen later, power management, a sensor interface, signal conditioning, a non-volatile memory, a back scatter modulator and demodulator and a computing and control logic are all fully integrated into a single RFID chip constituting the RFID transponder 3. The antenna 5 is then externally connected to this RFID chip.

The reader R can actuate the RFID chip/RFID transponder 3 and can, in turn, receive a back scatter electromagnetic signal containing sensor identification data and information about the state of the structure 1 being monitored. The shown system therefore allows single or networked piezoelectric elements to simultaneously convert ambient source energy provided by the structure 1 into electrical energy, to sense the state of the structure 1 and to wirelessly transmit information on the condition of the structure to an end user through the reader R for structural health monitoring of the structure 1.

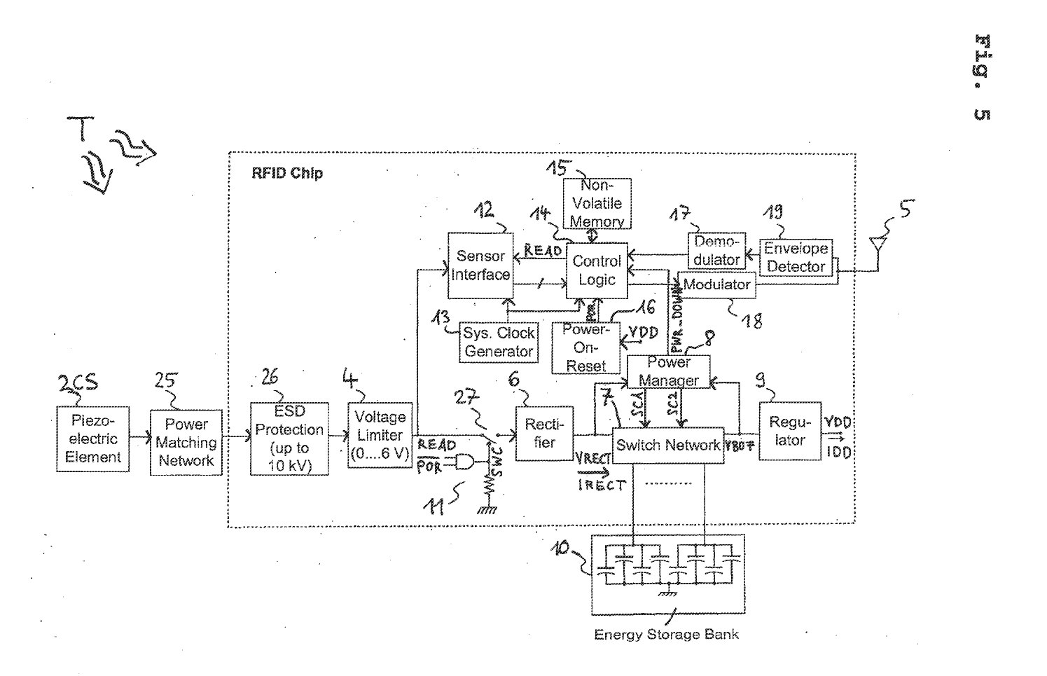

In some embodiments, the energy storage bank 10 can also be a supercapacitor or some other form of energy accumulation device. The actual type of energy storage device 10 determines the topology of the employed switch network (see FIG. 5).

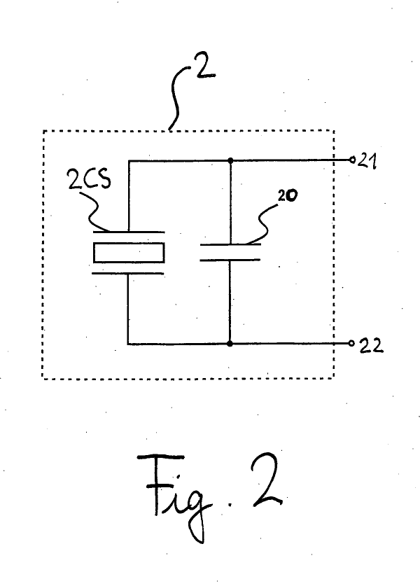

FIG. 2 illustrates one piezoelectric element, here one piezoelectric converting and sensing element 2CS, i.e. an element that converts kinetic energy in electrical energy and that generates sensing information, which can be used in the present invention. The piezoelectric element 2CS is connected in parallel with a voltage-limiting capacitor 20. Elements 21 and 22 are output terminals of this piezoelectric element-capacitor configuration. The internal impedance of the piezoelectric converting and sensing element 2CS is capacitive rather than inductive in nature. If the capacitance of the piezoelectric element is very small, the element may generate a very high output voltage. Therefore, the voltage-limiting capacitor 20 is used to adjust the output voltage of the piezoelectric element 2CS to a range suitable for system operation. In some embodiments, the output voltage between terminals 21 and 22 should be less than 3 V. The voltage-limiting capacitor 20 serves also as power-matching network 25 (see FIG. 5).

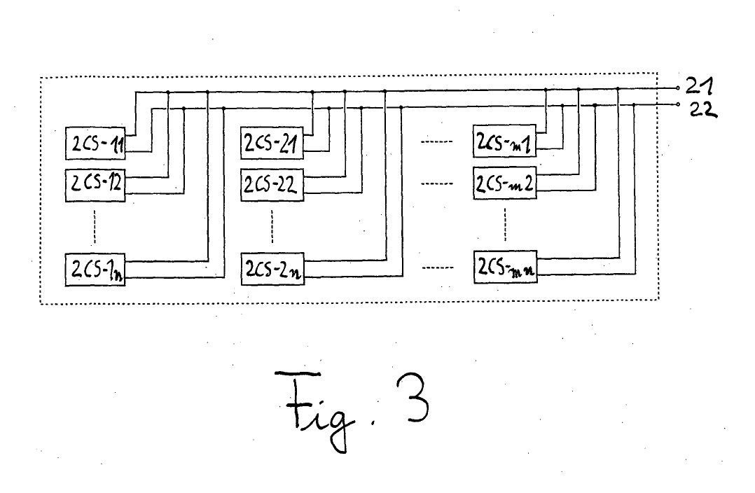

FIG. 3 shows a configuration of multiple piezoelectric converting and sensing elements 2CS which are all connected to one and the same output terminals 21, 22. All of the shown piezoelectric elements 2CS-11, 2CS-12, . . . , 2CS-1n, . . . , 2CS-m1, . . . , 2CS-nm are connected in parallel so that an accumulated signal of the individual signals of the single piezoelectric elements will be provided at the output terminals 21, 22. These networked piezoelectric elements for combined sensing and power harvesting can be implemented in accordance with the integrated circuit embodiment described in FIG. 5. Sensing information is generated by the average output of these multiple pieroelectric elements. The multiple piezoelectric elements are arranged at different surface locations and/or interior locations of the structure 1 in order to be able to detect stresses and/or vibrations of different locations of the structure. A single piezoelectric element is generally not in position to power the entire system (further described below).

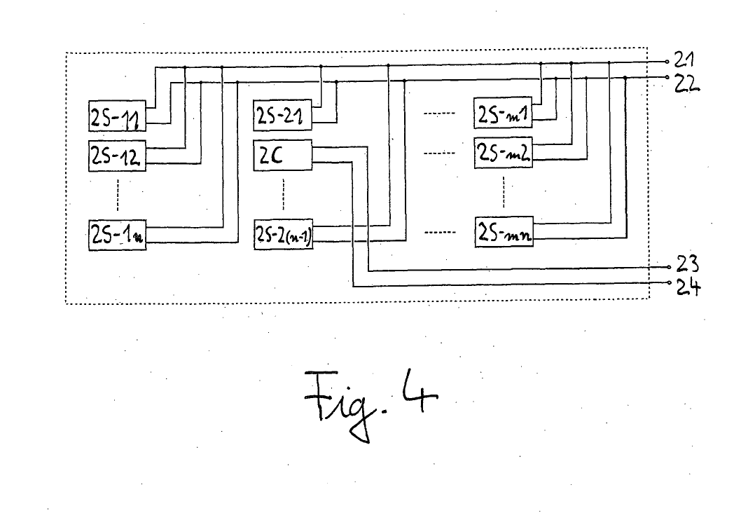

FIG. 4 discloses a similar structure as is disclosed in FIG. 3, however, here multiple piezoelectric elements, the piezoelectric elements 2C-11, . . . , 2C-mn are realized as piezoelectric converting elements (this means that these elements are only used to convert kinetic energy into electrical energy and not to generate sensing information: several parallel elements allow a higher energy gain). Therefore, the only piezoelectric element realized as piezoelectric sensing element is the element 2S shown in the center here (this element is therefore only used to generate sensing information with respect to the state of the structure 1, but not to convert kinetic energy into electrical energy). The piezoelectric sensing element 2S (of course also more than one element 2S could be used here) is then connected to the two output terminals 23, 24, whereas all piezoelectric converting elements 2C are connected in parallel and connected to two separate output terminals 21, 22.

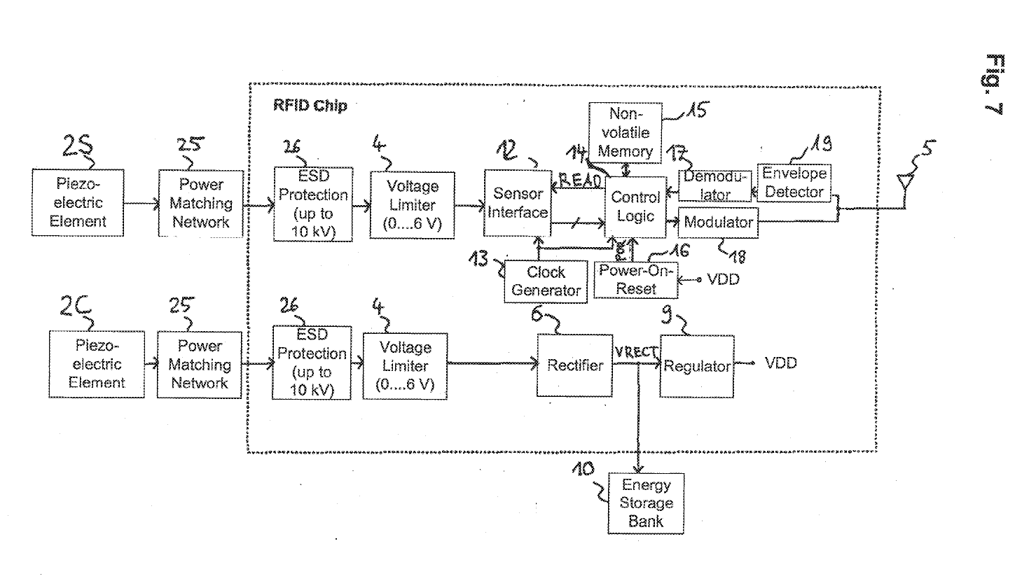

FIG. 4 therefore illustrates a schematic diagram of network piezoelectric elements for separated sensing and power harvesting, which can be implemented in accordance with an alternative embodiment of an RFID chip shown in FIG. 7 (the sensing element 2S is then connected to the sensor interface 12 and the converting elements 2C are connected to the rectifier 6 and the energy storage bank 10). The separation of the sensing element 2S and the power harvesting elements 2C allows for a simpler on-chip circuitry with improved noise rejection properties compared to the configuration shown in FIGS. 3 and 5.

FIG. 5 shows the interior of an RFID transponder 3 integrated into one chip that can be used together with the network shown in FIG. 3. The piezoelectric converting and sensing elements 2CS are connected via power-matching network 25 (FIG. 2) with an input terminal of the RFID chip 3 (single sensing and power harvesting input to which the piezoelectric elements 2CS with their power-matching network 25 are connected).

Connected to the input terminal (not shown) of the RFID chip 3 is an electrostatic discharge (ESD) protection 26 of the chip 3 adapted to avoid chip damage during handling. Connected to this ESD protection 26 is a voltage limiter 4 which provides a low impedance path for all input voltages higher than a pre-established safety voltage, thus avoiding irreversible damage of the internal electronics of the RFID chip 3. In some embodiment, this pre-established safety voltage is set to 6 V here, but can be also set to 3V.

On the output side of the voltage limiter 4 (seen from the input terminal of the RFID chip 3) the electrical connection splits up in two branches. A first branch (energy branch) is adapted to use the electrical energy delivered by the piezoelectrical elements 2CS for powering the RFID chip 3 and the antenna 5 and a second branch (sensing branch) is adapted to use the electrical signal provided by the piezoelectric elements 2CS in order to generate sensing information with respect to a state of the structure 1. The first branch substantially includes the elements 6 to 9, 11 and 27 (described below) and the externally connected energy storage bank 10, and the second branch substantially includes the elements 12 to 19 (described below) and the externally connected antenna 5.

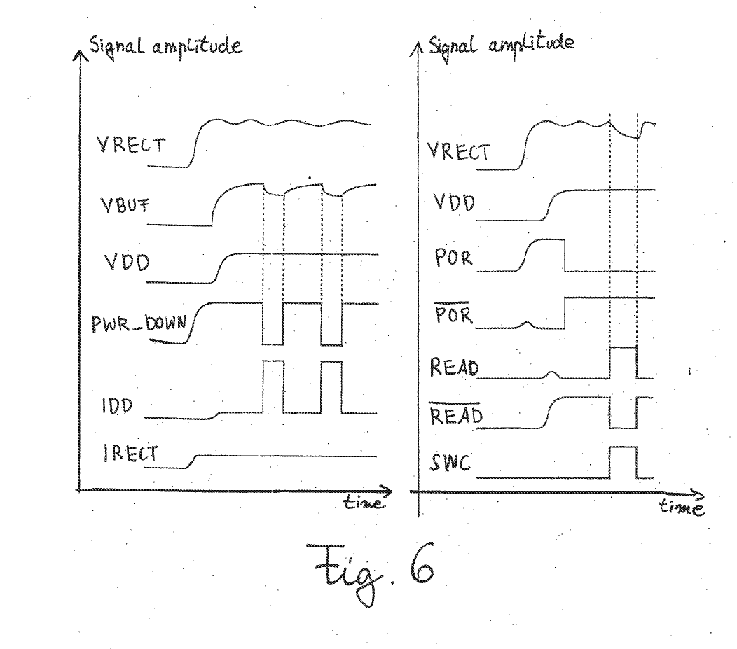

In the first branch (energy branch), in order to separate this branch from the piezoelectric elements 2CS during a sensor signal measurement with the second branch (sensing branch) for avoiding the introduction of noise in this measurement, a PMOS switch 27 is provided (element 11 is an AND gate with a pull-down resistor to establish a predefined signal level during transponder power-up). This switch remains closed as long as the signal SWC is grounded. The latter is initially achieved with a pull-down resistor. An AND gate driven by the signals READ and P̅O̅R̅ opens the PMOS switch 11, 27 during the sensor measurement. In this situation, the energy storage bank 10 provides power to the entire system, i.e. the RFID chip 3. A time diagram showing the related signals can be seen in FIG. 6, right-hand side: When the READ signal (i.e. perform a measurement) is asserted, the SWC signal goes high disconnecting the rectifier from the input, thus achieving a low-noise measurement. The rectified voltage VRECT slowly decreases during the measurement procedure because the rectifier 6 remains disconnected and the energy storage bank 10 is being discharged. VDD should remain stable during the whole procedure. The POR signal goes high during power-up and is asserted low when the output voltage VDD is stable.

In the energy branch, on the output side of the switch 11, 27, a rectifier 6 is arranged. This rectifier circuit converts the input AC signal from the piezoelectric elements 2CS into a DC signal, which is subsequently stored in the external energy storage bank 10. In order to do so, a switch network 7 (to which the DC signal is fed) is used. The switch network 7 is connected to the rectifier 6 and to a power manager 8. This power management circuit 8 controls the switching network 7 with the two signals SC1 and SC2. SC1 and SC2 are non-overlapping clocks.

On the other hand, the switch network 7 is connected to the external energy storage bank 10 in order to allow the switch network to store the rectified voltage of the piezoelectric elements 2CS in the energy storage bank 10. The switching network 7 stores the energy input to it via the rectifier 6 in the energy storage bank 10 in such a way as to provide a larger output current during short periods of time for duty-cycle operations. As indicated in FIG. 6 left hand, the energy stored in the energy storage bank can be released in short burst (duty cycle operation). This is seen in the higher current consumption and corresponding discharging depicted by the signal VBUF when the signal PWR_DOWN goes low. PWR_DOWN remains asserted (i.e. “HIGH”) when the system is working in low power mode.

A voltage regulator 9 adapted to provide a stable, temperature-independent voltage supply is connected to the power management circuit 8 and to the switch network 7.

The signal VBUF is the voltage provided at the output of the switch network that may vary according to variations on the mechanical stress or vibration of the structure. The voltage regulator suppresses these variations, providing the rest of the transponder circuits with a stable power supply (VDD). VDD is distributed to the rest of the chip. Large variations in VDD (supposing that no voltage regulator is employed) would significantly deteriorate the performance of the whole chip (i.e. an additional source of noise), particularly the sensitive analog circuitry in the sensor interface.

The power management circuit 8 monitors the input voltage (VBUF) of the voltage regulator 9 and provides an adequate timing to the switch network 7. The power management circuit 8 also generates a power-down signal PWR_DOWN that, if provided, sets the entire system, i.e. the RFID chip or most of its subsystems, in a low-power operation mode. To do so, the PWR_DOWN signal generated by the power management circuit 8 indicates the main control unit 14 (of the sensing branch, see below) a low power level in the energy storage bank 10, thus triggering with help of the main control unit 14 a system level low-power operation mode. To this end, the voltage level VBUF is constantly monitored by the power management circuit 8.

The RFID transponder 3 shown in FIG. 5 therefore operates as a semi-active RFID transponder. This low-power operation mode or a corresponding duty-cycle operation, respectively, is realized for the case that very low power is provided by the piezoelectric elements 2CS (e.g. there may cases occur in which only one element arranged on the structure 1 provides power). During the low-power operation mode, only a few functional blocks are actively working in the shown system, thus reducing a current drain from the energy storage bank 10 and allowing the voltage VBUF to recover. A time diagram showing the related signals can be seen in FIG. 6, left-hand side. The corresponding duty cycle is controlled by a self-regulated process that depends on the energy level stored in the energy storage bank 10. In low-power mode, the system provides only basic (and/or high-priority) functionalities, thus allowing the building up of energy in the energy storage bank 10. The functional blocks that are actively working during low power mode in FIG. 5 are:

RF front end (envelope detector, demodulator, modulator, requiring virtually no power due its passive nature in passive RFID transponders), selected functionality of the main control logic 14, rectifier, power manager, switch network and regulator.

The low-power operation mode is normally implemented at relatively high-level (i.e. in software) and is restricted to the repetitive usage of energy demanding operations (like performing a measurement, writing to memory, or executing repetitive routines like those required for digital signal processing, for instance to clean up measurement data from spurious noise). Thus, besides disconnecting (i.e. power down) some obvious subsystems like the sensor interface, which contains quite a bit of analog circuitry requiring excessive power, there are not many differences at hardware level (or low-level) between normal and powerdown modes.

By self-regulated process is meant that the system is working in a closed feedback loop. That is, as soon as the energy level is reestablished the system goes into normal operation, demanding once more high power. To avoid excessive oscillation, the system features hysteresis, thus providing for a significant “normal operation” time period before going once again into low-power mode.

In the second branch (sensing branch) the signal provided by the piezoelectric elements 2CS is input to a sensor interface 12. This sensor interface 12 measures therefore the voltage output generated by the stress or vibrations of the piezoelectric elements 2CS. The voltage output is proportional to the level of stress and vibration of the structure 1. Therefore, stress-based and vibration-based structure health monitoring can be carried out. Alternatively, however, the sensor interface 12 can also be adapted to measure variations of the electrical impedance of the piezoelectric elements 2CS. Then, impedance-based structure health monitoring can be carried out.

In the illustrated configuration, the sensor interface 12 periodically samples the voltage-limited sensor signal provided from the piezoelectric elements 2CS via the voltage limiter 4 and digitizes it. The digitized sensor signal is then fetched by the main control logic circuit 14 (control logic) connected to the sensor interface 12 and stored in a non-volatile memory 15 that is connected to the control logic 14. The non-volatile memory 15 can therefore store data associated with the state of the structure, it can also store additional identification information for example about specific piezoelectric elements 2CS or the like. The sensor interface 12 can also condition the sensor signal before it is digitized and stored in the non-volatile memory 15. The configuration of the sensor interface 12 depends upon which structural parameter of the structure 1 is monitored.

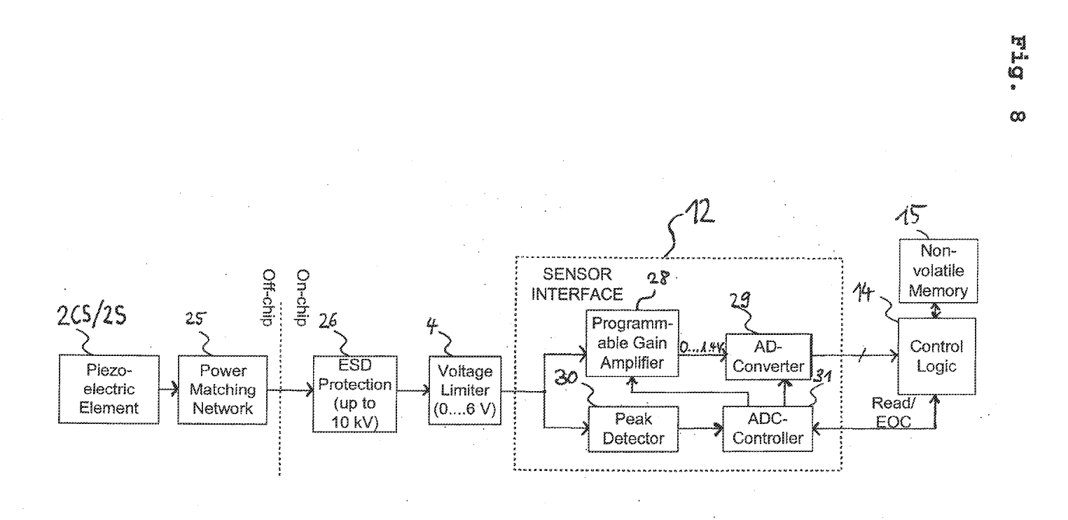

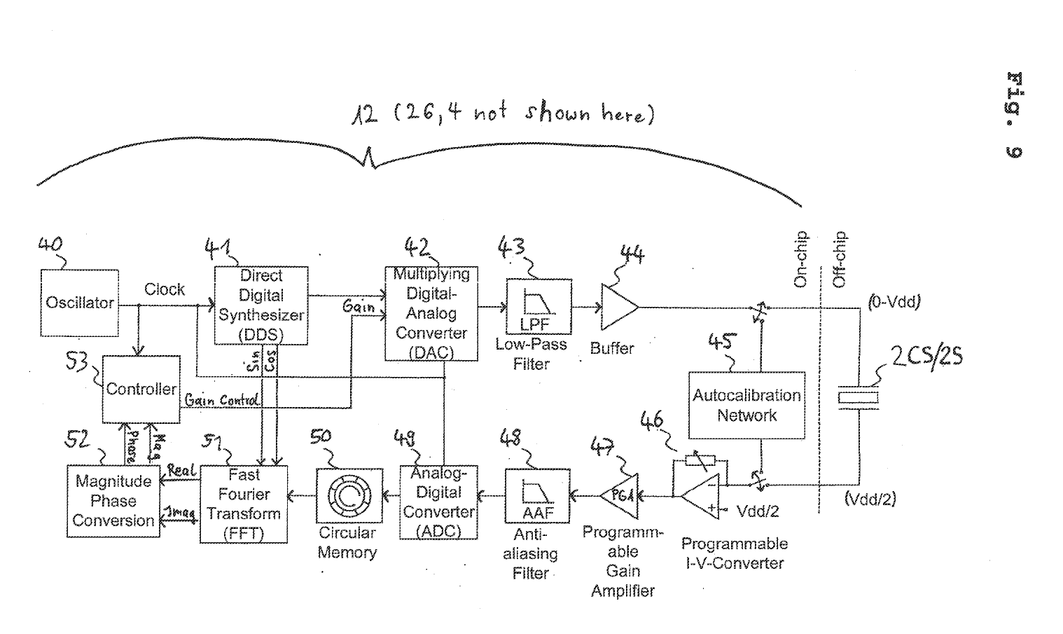

In some embodiments, and as indicated in FIGS. 8 and 9, the sensor signal must be amplified and filtered (antialising filter) before being sampled (i.e. digitized). The signal conditioning that takes place is therefore amplification and filtering. The configuration of the sensor interface is selected by closing and opening not shown switches. FIGS. 8 and 9 are shown as two independent configurations to avoid unnecessary cluttering in a single diagram. The configuration switches are activated by appropriate control signals provided by the main control logic 14.

Alternatively or in addition to storing the signal in the non-volatile memory 15, the signal can be sent to a back scatter modulator 18 connected to the main control logic 14 in order to relay it to a querying reader station R. To do so, the back scatter modulator 18 is connected to the antenna 5. The back scatter modulator 18 can be adapted to produce a deliberate mismatch between the RFID chip 3 and the antenna 5, thus reflecting part of the incident electromagnetic energy. This modulator can therefore provide a backward communication link between the RFID chip 3 and the querying reader R.

The back scatter principle which can be employed here is based on the so called “impedance matching” between the antenna (having a complex impedance A+jB) and the input impedance of the chip (having a complex impedance A−jB). When both impedances are matched the real parts of the impedances are equal and the imaginary parts of the impedances differ in sign. In this situation the power transfer from antenna into the chip is maximum and no power reflection takes place. The antenna impedance is fixed since it is a passive element whose characteristics are given by its geometrical dimensions and the employed materials. The input impedance of the chip can be deliberately altered for example by connecting a capacitor in parallel to the antenna by means of a switch. In this case, since the impedances are no longer matched, part of the incident energy will be reflected or back scattered (like a mirror). The reader can then detect this reflected energy and thus a backward communication (tag→reader) takes place. The switch and capacitor mentioned above constitute a simple modulator 18 controlled by the main control logic 14.

Also connected to the control logic 14 is a demodulator 17, to which an envelope detector 19 is connected. When an RFID-based reader transmits a querying signal to the shown RFID chip, this querying signal is received by antenna 5 and (via a connection of antenna 5 with the envelope detector 19) the envelope detector 19 determines the profile of this input signal (which can be an ASK-modulated RF input signal) provided by the antenna 5. The demodulator 17 then provides a digital base-band signal to the control logic 14. The digital base-band signal can be extracted from the envelope of the ASK-modulated RF signal and provided to the control logic 14.

Finally, a system clock generator 13 is connected to the sensor interface 12 and to the main control logic 14. This system clock generator 13 furnishes the clock signal for the entire system, especially supplies the main clock signal for the control logic unit 14.

Also connected to the control logic 14 is a power-on-reset circuit 16 which monitors the regulated power supply VDD eventually providing an initialization signal POR for the sequential logic in the RFID chip 3. Sequential logic is logic containing memory elements like flip-flops and latches. This digital elements need a reset signal upon system powerup in order to be set to a known state, “LOW” generally. A typical example of sequential logic is a finite state machine (FSM) used to perform a series of sequential tasks. A FSM has a so called state register made up of n bits (n flip-flops) which need initialization so that the FSM can start from a known initial state (say “0000” for a 4-bit state register). Most intelligent subsystems in the RFID chip are controlled by their own FSM. During power-up VDD goes from low to high voltage levels. The Power-On-Reset (POR) circuit generates a POR signal (a reset signal) based on the state of VDD.

If, therefore, a distant reader R transmits a querying signal, this signal is received by antenna 5, i.e. an AC signal is induced at the chip's input terminal connected to the antenna 5 and the signal is treated as described above. The shown RFID transponder can therefore operate as a sensing device providing identification data (e.g. of the piezoelectric elements 2CS or of the structure 1) and state information of the structure 1 being monitored upon request from the reader R.

FIG. 7 shows an alternative embodiment, which is similar to the embodiment described in FIGS. 5 and 6. Therefore, only the differences of this embodiment are now depicted: In the embodiment of FIG. 7, the two branches, i.e. the sensing branch and the energy branch are nearly completely separated by connecting a first group of piezoelectric elements (the piezoelectric sensing elements 2S) with the sensing branch and by connecting a second group of piezoelectric elements (the piezoelectric converting element 2C, compare FIG. 4) with the energy branch. Therefore, the signal processing with respect to the energy harvesting and the signal processing with respect to the sensing of the state of the structure 1 are completely separated, so that the PMOS switch 27 and the pull-down circuit 11, the power management circuit 8 and the switch network 7 of the configuration in FIG. 5 are not necessary. FIG. 7 therefore illustrates another embodiment of the RFID chip 3 according to the invention with separated channels for the sensing and the power harvesting. Since sensor and power channels are independent of each other, system powering and sensor queries can occur simultaneously. Further, an improved noise rejection can be achieved due to the lower cross talk between the power harvesting channel (energy branch) and the sensor channel (sensing branch).

FIG. 8 discloses one possible embodiment for the sensor interface 12 of the present invention. FIG. 8 shows the sensor interface 12 in an amplitude measurement configuration of the RFID chip 3. The piezoelectric elements 2CS or 2S with their power matching network 25 (“off-chip”, i.e. not integrated into the RFID chip 3) provide a sensor signal which is fed into the sensor interface 12 through a number of protections also integrated into the RFID chip 3: The ESD protection circuit 26 avoiding chip damage up to 10 kV and the voltage limiter 4 reducing signal swing up to approximately 6V and thus precluding premature aging due to voltage stress.

The sensor interface 12 (including the elements 28 to 31) is then provided with a peak detector 30 connected to the voltage limiter 4 and generating a thermometer-encoded signal. A thermometer-encoded signal uses n binary digits to code n values. For instance, 0 “0000”, 1→“0001”, 2→“0011”, 3→“0111” and 4→“1111” in thermometer code, whereas binary coding the range 0 - 3 requires 2 bits: 0→“00”, 1→“01”, 2→“10” and 3→“11” (4→“100”). The implementation of the peak detector is such that it can supply a thermometer-encoded representation of the input signal's peak value with no further processing.

Connected to the peak detector 30 is an ADC controller 31 which employs the thermometer-encoded signal to adjust the gain of a programmable gain amplifier 28 connected to the voltage limiter 4 and to the ADC controller 31. The peak detector supplies the ADC controller with a signal indicating the maximal amplitude of the sensor signal. The ADC controller if necessary attenuates or amplifies the input signal to the AD-converter. An overflow bit in the AD-converter provides information on a possible saturation of the AD-converter, which is used by the ADC controller to further adjust the gain of the programmable gain amplifier. Connected to the output side of the programmable gain amplifier 28 and to the output side of the ADC controller 31 is an AD converter 29.

By the described signal processing, the dynamic range of the AD converter 29 can be optimally exploited (the output of the AD converter 29 is connected to the main control logic 14). The control logic 14 is connected to the ADC controller 31. The READ signal provided by the control logic 14 starts a new conversion and is kept asserted until an EOC signal of the control logic 14 indicates the end of the conversion process. The main control logic 14 then fetches the digitized word and stores it in the non-volatile memory 15.

FIG. 9 illustrates an alternative embodiment for the sensor interface 12 of the present invention. The shown sensor interface 12 is realized in the impedance measurement configuration and includes the elements 40 to 53 described below.

An oscillator 40 provides a signal with a reference frequency. This clock signal is fed to a direct digital synthesizer DDS 41 connected to the oscillator 40. The DDS 41 generates high-purity sine and cosine waves in digital form. The DDS 41 can achieve a fine-graded frequency sweep by means of a high-resolution phase stepping scheme. Connected to the DDS 41 is a multiplying digital-analog converter 42 which takes a digital input and converts it into an analog signal. A controller 53 connected with one of its input terminals to the output side of the oscillator 40 is connected with its output side to an input terminal of the multiplying digital-analog converter 42. This controller 53 may adjust the gain of the multiplying DAC 42, in order to compensate variations along the loop gain (this controller 53 may adjust the gain of the multiplying DAC 42 by changing (programming) the DAC's reference current, in order to compensate gain variations along the loop). A low-pass filter 43 connected to the output side of the DAC 42 eliminates high-frequency components and smoothes the output waveform of the DAC 42. Connected to the output side of the low-pass filter 43 is a buffer 44 which provides a current boost in case of a low-impedance load (which is/are in the present case the piezoelectric element(s) 2CS or 2S).

An auto-calibration network 45 that introduces a mechanism to determine the actual loop gain and thus to correct gain variations along the send and the receive paths can be connected to the output side of the buffer 44. To allow this, a switch is provided with which, instead of the piezoelectric arrangement 2, the auto-calibration network 45 can be connected to the described elements. In other words, the output side of the buffer 44 can be alternately coupled to the auto-calibration network 45 or to one of the terminals of the piezoelectric arrangement/the piezoelectric elements.

The auto-calibration network consists in the simplest case of a single wire joining (short-circuiting) send- and receive-paths. In this way, independently of what type of impedance is connected, it is possible to determine the unloaded system gain (note that there are amplifiers and other analog components along the loop whose gain is not well-known) and by adjusting for instance the DAC-gain, saturation can be avoided at the ADC input. The auto-calibration network may also have a parallel-connected (eventually external) precision resistor whose value should be comparable to that of the impedance to be measured. This would assure a more precise auto-calibration (i.e. internal gain adjustment to avoid ADC saturation and also to achieve a correct impedance value).

In a similar way, one input terminal of a programmable I-V converter 46 can be alternately coupled (with help of a further switch) to the other terminal of the auto-calibration network 45 or to the other terminal of the piezoelectric arrangement 2, i.e. the piezoelectric elements 2CS or 2S. This programmable I-V converter 46 establishes a fixed voltage (Vdd/2, i.e. the floating ground potential) at the input side of the receive path (the send path comprises the elements 40 to 44, the receive path the programmable I-V converter 46 and the elements 47 to 52 described below) so that the synthesized sine wave drops across the piezoelectric arrangement 2. The current voltage gain of the I-V converter 46 can be adjusted to accommodate different loads or piezoelectric arrangements 2, respectively.

The transfer characteristic of the IV-converter with a resistor R in its feedback network is Vout/Iin=−R, so that by simply having two or three parallel-connected resistors in series with switches, it is possible to change the gain of the IV-converter. The gain may have to be changed in case that the impedance to be measured is too low, which would produce a very large current and thus saturate (or destroy) the receive path.

Connected to the output side of the I-V converter 46 is a programmable gain amplifier PGA 47 that scales the signal to fully exploit the dynamic range of an analog-digital converter ADC 49 provided subsequently in the receive path. Between the PGA 47 and the ADC 49, an anti-aliasing filter 48 is arranged that suppresses undesired out-of-band frequency components.

The digitized signal provided by the ADC 49 is then stored in a circular memory 50 connected to the output side of the ADC 49. Connected with the circular memory 50 is a fast fourier transform unit (FFT unit 51) which calculates the complex fourier transform of the information stored in the circular memory 50, yielding a real and an imaginary word for every frequency step. The real and the imaginary part output by the FFT unit 51 are converted to the equivalent magnitude and phase by a magnitude phase conversion block 52 whose input terminals are connected to the FFT unit 51 and whose output terminals are connected to the controller 53.

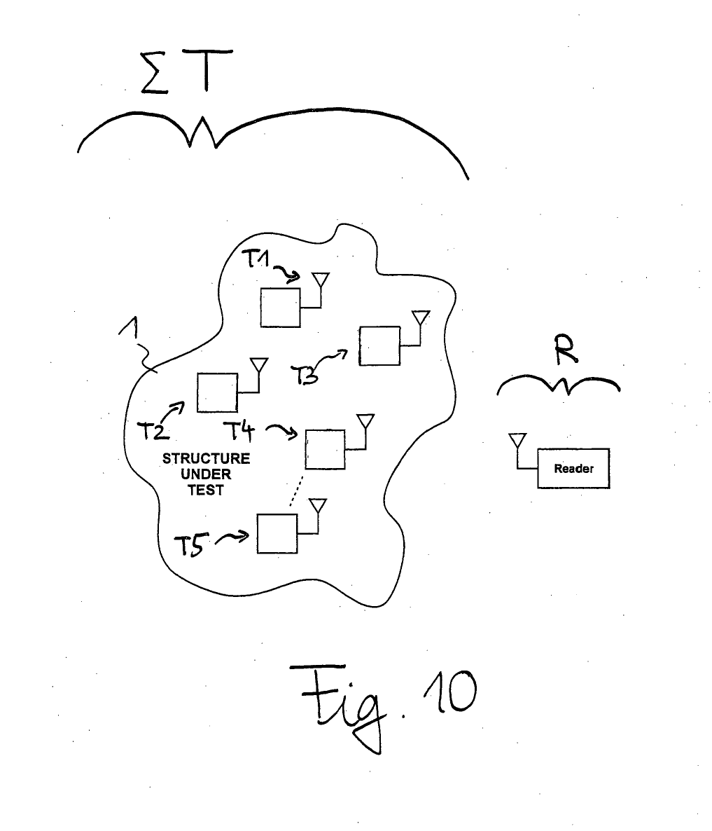

FIG. 10 discloses an RFID-based sensing and reading system according to the present invention that includes multiple RFID-based sensing system T according to the invention and one single RFID-based reader R. As can be seen, all of those sensing systems T1, . . . , T5 are arranged in direct contact with the structure 1 under test. The sensing systems T1, . . . , T5 can be arranged at different locations on the surface and/or on the inside of said structure 1. FIG. 10 therefore illustrates an RFID-based wireless sensor network according to the present invention in which one or more sensor nodes (the single sensor systems or transmitters T, respectively) each including at least one, in some embodiments more than one piezoelectric element(s), incorporated into the structure or arranged at the surface of the structure. The reader R located at a distance of the structure 1 can then sequentially read identification and sensing information from all sensor nodes or transmitters T, respectively, in this wireless sensor network.

FIG. 10 thus illustrates one important idea of the present invention: to organize several single sensing systems (each including a piezoelectric arrangement with one or more piezoelectric elements) or transmitters, respectively, into a sensor network with several nodes and to use one single reader to read all sensor nodes. In this case, the single sensor systems T1, . . . , T5 are mounted on one structure, however, of course, they can also be mounted on different structures (e.g. systems T1 to T2 on a first structure and systems T3 to T5 on a second structure). The reader R can read the nodes/systems T1 to T5 simultaneously (or in another configuration also sequentially). Each sensor node/sensing system T1 to T5 can have a unique identification information (e.g. stored in its RFID transponder) which can be read by reader R.

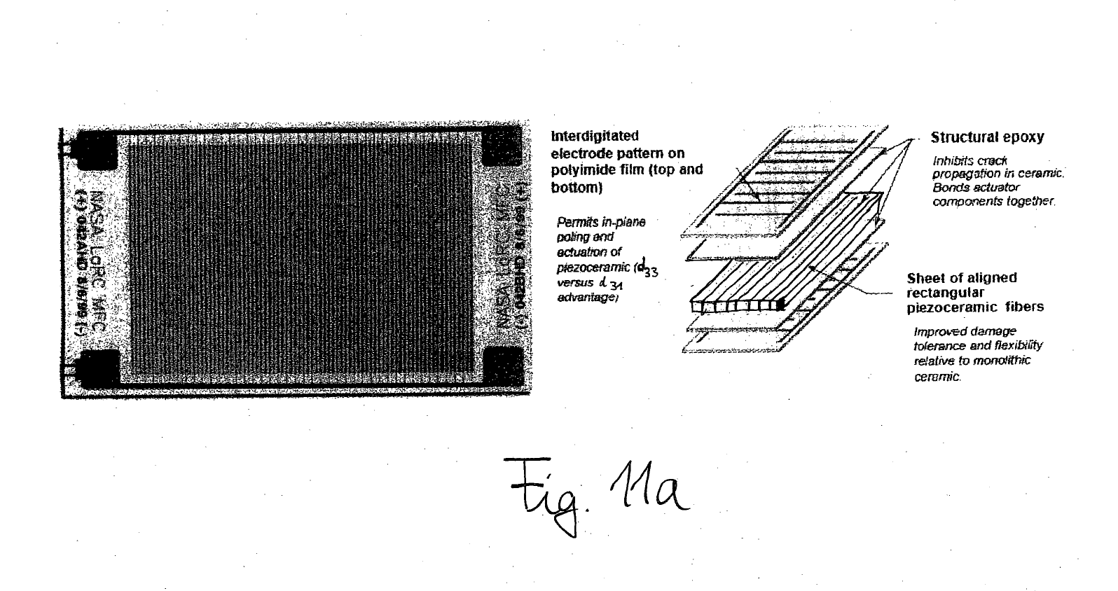

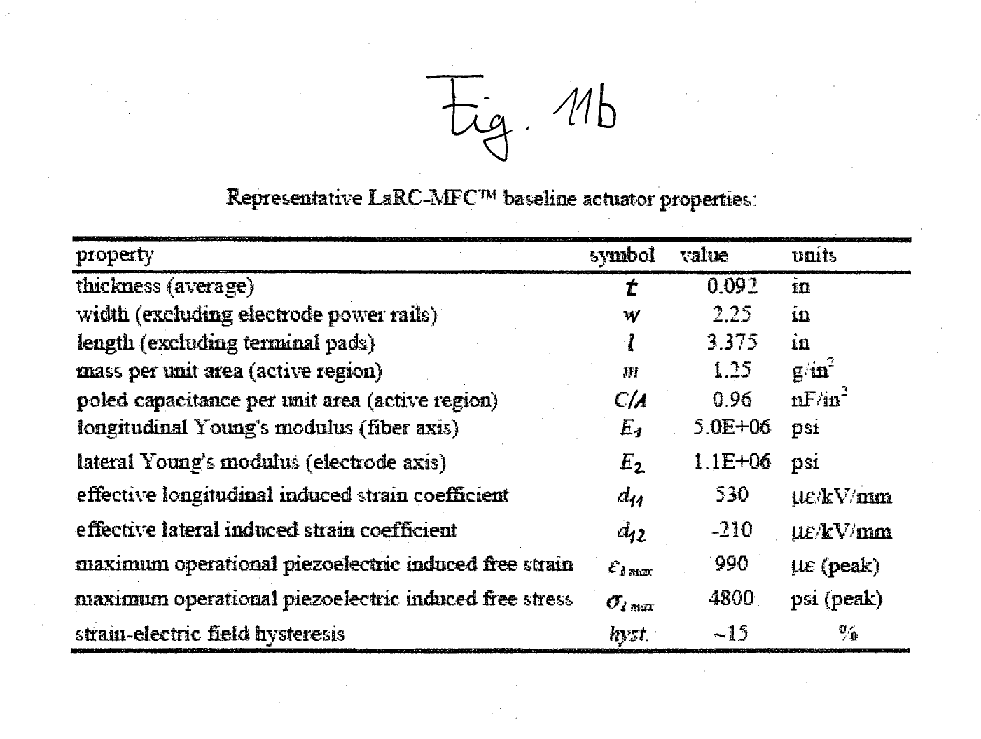

FIG. 11 illustrates a macro-fiber composite actuator (MFC) of the prior art which is one type of a piezoelectric element 2CS, 2S or 2C that can be used in the present invention. This MFC actuator consists of thin PZT fibers embedded in a KAPTON film and covered with an interdigitated electrode. Due to the MFC construction using piezoelectric fibers, the overall mechanical strength of the element is greatly increased compared to that of the base material, nevertheless providing an enhanced flexibility. The interdigitated electrodes force the applied electric field to run axially, thus allowing the higher d₃₃ coefficient to come into play, rather than the d₃₁ coefficient active in a monolithic PZT.

1-22. (canceled)

23. An RFID-based sensing system comprising:
a piezoelectric arrangement adapted to be mountable and/or being mounted at least partially on a structure;
an RFID transponder adapted to be connected and/or being connected to the piezoelectric arrangement; and
an antenna adapted to be connected and/or being connected to the RFID transponder and/or being integrated into the RFID transponder;
wherein at least one of the piezoelectric arrangement and the RFID transponder is adapted to convert kinetic energy provided by the structure into electrical energy used and/or usable for powering at least one of the RFID transponder and the antenna and to generate sensing information with respect to a state of the structure, and
wherein the antenna is adapted to transmit the sensing information and/or information derived therefrom to an RFID reader and/or to receive an RF signal from the reader.

24. An RFID-based sensing system according to claim 23, wherein the piezoelectric arrangement comprises at least one piezoelectric element, and wherein at least one of the piezoelectric element(s) is/are adapted to be mounted and/or mounted on the structure and adapted to be connected and/or connected to the RFID transponder.

25. An RFID-based sensing system according claim 24, wherein the piezoelectric arrangement comprises at least one piezoelectric converting and sensing element being adapted, to convert kinetic energy provided by the structure into electrical energy used and/or usable for powering the RFID transponder, and to generate sensing information with respect to a state of the structure.

26. An RFID-based sensing system according to claim 24, wherein the piezoelectric arrangement comprises:
at least one piezoelectric converting element being adapted to convert kinetic energy provided by the structure into electrical energy used and/or usable for powering the RFID transponder; and
at least one piezoelectric sensing element being adapted to generate sensing information with respect to a state of the structure.

27. An RFID-based sensing system according to claim 23, wherein at least one of the RFID transponder and the piezoelectric arrangement is adapted to alternately switch between a first state in which kinetic energy provided by the structure is converted into electrical energy used and/or usable for powering the RFID transponder and a second state in which sensing information with respect to a state of the structure is generated.

28. An RFID-based sensing system according to claim 23, wherein at least one of the RFID transponder and the piezoelectric arrangement comprises a sensor interface adapted to sample a signal resulting from at least one piezoelectric sensing element and/or piezoelectric converting and sensing element, to measure a voltage output generated by at least one piezoelectric sensing element and/or piezoelectric converting and sensing element and/or to measure a variation of the electrical impedance of one piezoelectric sensing element and/or piezoelectric converting and sensing element.

29. An RFID-based sensing system according to claim 28, wherein the sensor interface is further adapted to also generate the sensing information with respect to a state of the structure.

30. An RFID-based sensing system according to claim 28, wherein the sensor interface is adapted to digitize and/or to modify the resulting signal, the voltage output and/or the variation of the electrical impedance by amplification, attenuation or low-pass filtering or by offset-change of the signal's DC value.

31. An RFID-based sensing system according to claim 30, wherein at least one of the RFID transponder and the piezoelectric arrangement comprises)a memory, and wherein the sensor interface is adapted to store information associated with a state of the structure and/or identification information with respect to the RFID transponder and/or at least one piezoelectric element of the piezoelectric arrangement in the memory.

32. An RFID-based sensing system according to one claim 23, wherein at least one of the RFID transponder and the piezoelectric arrangement comprises an energy storage, the energy storage being adapted to store at least part of the electrical energy gained by conversion of the kinetic energy and adapted to power the RFID transponder.

33. An RFID-based sensing system according to claim 23, wherein the RFID transponder is connected to an energy storage.

34. An RFID-based sensing system according claim 32, further comprising a rectifier connected between the piezoelectric arrangement and the energy storage.

35. An RFID-based sensing system according to claim 32, wherein at least one of the RFID transponder and the piezoelectric arrangement is adapted to alternately switch between a first state, in which kinetic energy provided by the structure is converted into electrical energy and stored in the energy storage and in which no sensing information with respect to a state of the structure is generated, and a second state, in which sensing information with respect to a state of the structure is generated, but no energy is stored in the energy storage.

36. An RFID-based sensing system according to claim 23, wherein at least one of the RFID transponder and the piezoelectric arrangement comprises a power management circuit adapted to generate a power down signal that is able to set at least part of the RFID-based sensing system in a low-power operation mode in which only a restricted number of predefined functionalities is available.

37. An RFID-based sensing system according to claim 23, wherein the RFID transponder comprises, at an input terminal connected to the piezoelectric arrangement, a voltage limiter adapted to provide a low impedance path for input voltages higher than a predefined voltage threshold.

38. An RFID-based sensing system according to claim 23, wherein at least one of the RFID transponder and the piezoelectric arrangement comprises a voltage regulator adapted to provide a stable, temperature independent voltage supply for the RFID-based sensing system.

39. An RFID-based sensing system according to claim 23, wherein the RFID transponder comprises, at an output terminal connected to the antenna, an envelope detector adapted to determine an envelope shape of an amplitude modulated RF signal received by the antenna.

40. An RFID-based sensing system according to claim 39, wherein the RFID transponder comprises, connected to the envelope detector, a demodulator adapted to provide a base-band signal extracted from the envelope of an amplitude modulated RF signal received by the antenna.

41. An RFID-based sensing system according to claim 40, wherein the RFID transponder comprises, at an output terminal connected to the antenna, a modulator adapted to generate, from the sensing information and/or the information derived therefrom, a modulated signal to be transmitted by the antenna.

42. An RFID-based sensing system according to claim 40, wherein at least one of the RFID transponder and the piezoelectric arrangement comprises a main control logic circuit connected to the sensor interface, the memory, the demodulator and the modulator, the main control logic circuit being adapted to control the functionalities of the RFID-based sensing system.

43. An RFID-based sensing system according claim 42, wherein the RFID transponder comprises one integrated RFID chip to which the antenna is connected as an external antenna.

44. An RFID-based sensing system according claim 43, wherein the RFID chip comprises the sensor interface, the memory, the rectifier, the power management circuit, the voltage limiter, the voltage regulator, the envelope detector, the demodulator, the modulator and the main control logic circuit.

45. An RFID-based sensing system according to claim 23, wherein the RFID transponder comprises one of:
an active RFID transponder in which energy consumed by the RFID transponder can be provided by an external energy source;
a semi-passive RFID transponder in which energy consumed by the RFID transponder can be provided by at least one of the piezoelectric arrangement and the electromagnetic field radiated by an RFID-based reader; or
a passive RFID transponder in which energy consumed by the RFID transponder can be provided by at least one of the piezoelectric arrangement and the electromagnetic field radiated by an RFID-based reader.

46. An RFID-based sensing system according to claim 23, wherein the structure comprises one of a bridge, a building, a dam, a pipeline, a windmill, an aircraft, a car, a train or a ship.

47. An RFID-based sensing and reading system comprising:
at least one RFID-based sensing system, the at least one RFID-based sensing system including:
a piezoelectric arrangement mountable at least partially on a structure;
an RFID transponder connectable to the piezoelectric arrangement; and
an antenna connectable to or integrated with the RFID transponder;
at least one of the piezoelectric arrangement and the RFID transponder being adapted to convert kinetic energy provided by the structure into electrical energy used and/or usable for powering at least one of the RFID transponder and the antenna and to generate sensing information with respect to a state of the structure, and
at least one RFID based reader comprising a further antenna and being adapted to receive sensing information and/or information derived therefrom from the at least one RFID based sensing system and/or to transmit an RF signal to the at least one RFID based sensing system.

48. An RFID-based sensing and reading system according to claim 47, wherein the system includes multiple RFID-based sensing systems and exactly one RFID-based reader.

49. An RFID-based sensing and reading system according to claim 47, wherein at least one of the RFID-based sensing systems comprise a piezoelectric arrangement with multiple piezoelectric elements adapted to be mounted on or integrated in and/or being mounted on or integrated in a structure, and wherein at least one of the RFID-based readers is adapted to read sensing information and/or information derived therefrom from the multiple piezoelectric elements.

50. An RFID-based transmitting and receiving method in which a piezoelectric arrangement is mounted at least partially on a structure, an RFID transponder is connected to the piezoelectric arrangement, and an antenna is connected to the RFID transponder and/or integrated into the RFID transponder, the method comprising:
converting, via the piezoelectric arrangement and/or the RFID transponder, kinetic energy provided by the structure into electrical energy;
using the electrical energy to power the RFID transponder and to generate sensing information with respect to a state of the structure;
transmitting, via the antenna, the sending information and/or information derived therefrom, to an RFID reader; and
receiving the transmitted information via the RFID reader.
